(19) United States
(12) Patent Application Publication
(10) Pub. No.: US 2009/0300871 A1
(43) Pub. Date: Dec. 10, 2009

(54) Cyclone dust-collecting apparatus and vacuum cleaner having the same

(75) Inventors: Ji-won Seo, Gwangju-city (KR); Myoung-sun Choung, Gwangju-city (KR); Jang-keun Oh, Gwangju-city (KR); Dong-hun Yoo, Gwangju-city (KR); Min-ha Kim, Gwangju-city (KR)

Correspondence Address: Paul D. Greeley;Ohlandt, Greeley, Ruggiero & Perle, L.L.P., One Landmark Square, 10th Floor, Stamford, CT, 06901-2682, US

(73) Assignee: Samsung Gwangju Electronics Co., Ltd.

(21) Appl. No.: 12/288,385

(22) Filed: Oct. 20, 2008

(30) Foreign Application Priority Data
Jun. 10, 2008 (KR) 2008-54339

(51) Int. Cl. A47L 9/16; B01D 45/12; B01D 45/18

(52) U.S. Cl. 15/347; 55/346; 55/429

(57) ABSTRACT

A cyclone dust-collecting apparatus and vacuum cleaner having the cyclone dust-collecting apparatus are provided. The cyclone dust-collecting apparatus includes a cyclone unit comprising a primary cyclone unit having a grill filter formed therein, and a secondary cyclone unit fluidly communicating with the primary cyclone unit; a cover unit detachably disposed above the cyclone unit to discharge air discharged from the secondary cyclone unit; and a dust-collecting unit detachably disposed below the cyclone unit to collect dust separated by the primary cyclone unit and secondary cyclone unit, wherein air flows into the grill filter in the same direction as air flows into the primary cyclone unit.

### CROSS-REFERENCE TO RELATED APPLICATION

This application claims the benefit under 35 U.S.C. §119 from Korean Patent Application No. 10-2008-0054339, filed on Jun. 10, 2008, in the Korean Intellectual Property Office, which is incorporated herein by reference in its entirety.

### BACKGROUND OF THE INVENTION

1. Field of the Invention

The present disclosure relates to a cyclone dust-collecting apparatus and a vacuum cleaner having the cyclone dust-collecting apparatus. More particularly, the present disclosure relates to a cyclone dust-collecting apparatus to separate dust from air drawn into a cleaner main body through a suction port body connected to the cleaner main body from a surface being cleaned, to collect the separated dust, to discharge air from which dust has been separated outward from the cleaner main body, and a vacuum cleaner having the cyclone dust-collecting apparatus.

2. Description of the Related Art

A vacuum cleaner generates a suction force using a suction motor mounted in a cleaner main body, draws in dust or dirt along with air from a surface being cleaned through a suction port body using the suction force, separates dust from the air using a cyclone dust-collecting apparatus mounted in the cleaner main body, and discharges the air from which the dust has been removed from the cleaner main body.

Such a conventional cyclone dust-collecting apparatus includes a grill filter disposed inside a cyclone unit thereof. The grill filter includes a plurality of grill pores formed therein, to again filter air from which dust has been separated by the cyclone unit.

However, the plurality of grill pores of the grill filter are formed substantially perpendicular to a direction in which air flows into the cyclone unit, so vortexes in a stagnant flow may be formed on the trailing surface of the plurality of grill pores opposite the leading surface of the plurality of grill pores, which faces air whirling inside the cyclone unit, and accordingly, dust may pile up on the trailing surface of the plurality of grill pores. Such dust stacked on a portion of the grill filter may be drawn into the suction motor without additional filtering operations when a cleaner is operated again, so the suction motor may be damaged due to the dust. Alternatively, when dust blocks a portion of the grill filter, if the cleaner is operated, the pressure inside the cyclone unit may be reduced due to the dust.

The conventional cyclone dust-collecting apparatus is usually provided with a primary cyclone and secondary cyclone which have complicated shapes and are formed integrally with one another, so it is difficult to remove dust from the primary cyclone and secondary cyclone or to achieve maintenance and repair work.

Additionally, when the conventional cyclone dust-collecting apparatus is mounted in the cleaner main body, an inlet pipe of the cyclone dust-collecting apparatus may be incorrectly connected to a discharge port of the cleaner main body, due to design problems occurring when a mold is fabricated in order to form the cleaner main body.

Furthermore, a dust receptacle of the conventional cyclone dust-collecting apparatus to collect dust discharged from the cyclone unit is formed integrally with the cyclone unit, so if a user desires to empty the dust receptacle, he or she needs to separate the dust receptacle together with the cyclone unit from the cleaner main body, which causes user inconvenience.

### SUMMARY OF THE INVENTION

The present disclosure has been developed in order to solve the above described and other problems in the related art. Accordingly, an aspect of the present disclosure is to provide a cyclone dust-collecting apparatus in which performance is able to be improved and user convenience is increased, and a vacuum cleaner having the cyclone dust-collecting apparatus.

Another aspect of the present disclosure is to provide a cyclone dust-collecting apparatus that is able to reduce the pressure loss inside a cyclone unit and the loss of flow path, and a vacuum cleaner having the cyclone dust-collecting apparatus.

Another aspect of the present disclosure is to provide a cyclone dust-collecting apparatus in which maintenance and repair are facilitated by molding separately a primary cyclone unit and secondary cyclone unit of a cyclone unit, a first cover and second cover of a cover unit and a dust-collecting unit, and a vacuum cleaner having the cyclone dust-collecting apparatus.

The above aspects are achieved by providing a cyclone dust-collecting apparatus including a cyclone unit including a primary cyclone unit having a grill filter formed therein, and a secondary cyclone unit fluidly communicating with the primary cyclone unit; a cover unit detachably disposed above the cyclone unit to discharge air discharged from the secondary cyclone unit; and a dust-collecting unit detachably disposed below the cyclone unit to collect dust separated by the primary cyclone unit and secondary cyclone unit, wherein air flows into the grill filter in the same direction as air flows into the primary cyclone unit.

The grill filter may include a plurality of guide blades that extend from the outer surface thereof along the center of the grill filter, are spaced apart from each other by regular gaps and inclined in the same direction. Accordingly, it is possible to prevent vortexes in a stagnant flow from being formed on a trailing surface of the plurality of grill blades, and it is also possible to prevent dust from being stacked on the trailing surface of the plurality of grill pores, so the number of unnecessary flow paths may be reduced.

The primary cyclone unit may be detachably engaged with the secondary cyclone unit. Accordingly, the cyclone unit, cover unit and dust-collecting unit of the cyclone dust-collecting apparatus may be molded separately, so it is possible to facilitate maintenance and repair.

The primary cyclone unit may include a body having an inlet pipe formed in one side thereof; a cyclone chamber disposed inside the body while deviating from the center of the body; and a housing space partitioned from the cyclone chamber. The inlet pipe may be inclined by a first angle α (alpha) about a line L1 indicating the tangential direction of the cyclone chamber or by a second angle β (beta) upwards from a line L2 perpendicular to a center axis of the cyclone dust-collecting apparatus, or by both the first angle α (alpha) and second angle β (beta).

The first angle α (alpha) may desirably be in a range of 0 to 20 degrees, because if the first angle α (alpha) is less than 0 degrees, air may directly collide with an inner wall of the cyclone chamber, so the whirling force, and thus the dust-collecting efficiency, may be reduced. Alternatively, if the first angle α (alpha) is greater than 20 degrees, drawn-in air may directly collide-with the grill filter, so the whirling force may be reduced, and dust contained in the air which has not been filtered may flow into the grill filter and may block some portion of the grill filter, which causes a reduction in the suction force inside the cyclone chamber and weakens the functioning of the grill filter.

The second angle β (beta) may be in a range of 0 to 30 degrees, because if the second angel β (beta) is less than 0 degrees, drawn-in air may flow upwards inside the cyclone chamber and thus collide with an upper inner surface of the partition wall, so the whirling force, and thus the efficiency for centrifugally separating dust and air, may be reduced. Alternatively, if the second angel β (beta) is greater than 30 degrees, air may flow towards the bottom of the cyclone chamber, so a flow path by which air from which dust has been separated flows towards the grill filter may become longer, which causes pressure loss and a reduction in the suction force to draw in dust.

As described above, the inlet pipe may be inclined by the first angle α (alpha) and/or second angle β (beta) in which it is possible to minimize the pressure loss and a reduction in the suction efficiency of the cyclone unit, so it is possible to conceal design problems occurring when a mold is fabricated in order to form the cleaner main body.

The secondary cyclone unit may include a plurality of cones that are received in the housing space of the primary cyclone unit to enclose one side of the cyclone chamber. Bottom ends of the plurality of cones may be in contact with or disposed above a bottom end of the body of the primary cyclone unit. Accordingly, when a user desires to detach the dust-collecting unit from the cleaner main body, it is possible to prevent the plurality of cones from interfering with the dust-collecting unit, so the user can easily remove the dust-collecting unit from the cleaner main body.

The cover unit may include a first cover having a plurality of discharge pipes disposed above the plurality of cones to guide air discharged from the secondary cyclone unit; and a second cover including a confluent chamber in which air discharged via the plurality of discharge pipes is collected, and an outlet pipe to discharge the air collected in the confluent chamber from the cyclone dust-collecting apparatus. In this situation, a gasket may be inserted between the first cover and secondary cyclone unit to form an airtight seal on an upper portion of the secondary cyclone unit.

The above aspects are achieved by providing a cyclone dust-collecting apparatus including a cyclone unit including a primary cyclone unit including an inlet pipe and a cyclone chamber in which a grill filter is disposed, and a secondary cyclone unit fluidly communicating with the primary cyclone unit and having a plurality of cones enclosing one side of the cyclone chamber; a cover unit detachably disposed above the cyclone unit to temporarily accept air discharged from the secondary cyclone unit, the cover unit having an outlet pipe disposed on one side thereof to discharge the accepted air; and a dust-collecting unit detachably disposed below the cyclone unit, the dust-collecting unit including a primary dust-collecting chamber and secondary dust-collecting chamber that are partitioned from each other to collect dust separated by the primary cyclone unit and secondary cyclone unit, wherein the grill filter includes a plurality of guide blades that extend from the outer surface thereof along the center of the grill filter, are spaced apart from each other by regular gaps and inclined in the same direction, in order to cause air to flow into the grill filter in the same direction as air flows into the primary cyclone unit.

The above aspects are achieved by providing a cyclone dust-collecting apparatus including a cyclone unit including a grill filter disposed therein and an inlet pipe disposed on one side thereof; and a dust-collecting unit detachably disposed below the cyclone unit, wherein a center axis of the inlet pipe is disposed between the grill filter and the cyclone unit.

The above aspects are achieved by providing a vacuum cleaner apparatus including a cleaner main body including a suction motor mounted therein; a suction port body hingeably connected to a lower portion of the cleaner main body in fluid communication therebetween; a cyclone dust-collecting apparatus, as described above, mounted in the cleaner main body; and a lift unit disposed below the cyclone dust-collecting apparatus in the cleaner main body, wherein the lift unit securely fastens the dust-collecting unit to the cyclone unit in cleaning mode, or separates the dust-collecting unit from the cyclone unit in order to detach the dust-collecting unit from the cleaner main body.

### BRIEF DESCRIPTION OF THE SEVERAL VIEWS OF THE DRAWINGS

These and/or other aspects and advantages of the disclosure will become apparent and more readily appreciated from the following description of the embodiments, and accompanying drawings in which:

FIG. 1 is a perspective view of a vacuum cleaner having a cyclone dust-collecting apparatus according to an exemplary embodiment of the present disclosure;

FIG. 2 is a perspective view of a dust-collecting unit and lift unit of the vacuum cleaner of FIG. 1;

FIG. 3 is a perspective view of the cyclone dust-collecting apparatus of the vacuum cleaner of FIG. 1;

FIG. 4 is an exploded perspective view of the cyclone dust-collecting apparatus of FIG. 3;

FIG. 5 is a top view of the cyclone dust-collecting apparatus of FIG. 3;

FIG. 6 is a side view of the cyclone dust-collecting apparatus of FIG. 3;

FIG. 7 is a sectional view of a cyclone unit, taken along line VII-VII in FIG. 5;

FIG. 8 is an enlarged view of portion VIII of FIG. 7;

FIG. 9 is a section view of a cyclone unit, taken along line IX-IX in FIG. 6; and

FIG. 10 is an enlarged view of portion X of FIG. 9.

Throughout the drawings, like reference numerals will be understood to refer to like parts, components and structures.

### DETAILED DESCRIPTION OF THE INVENTION

Hereinafter, a cyclone dust-collecting apparatus and vacuum cleaner having the cyclone dust-collecting apparatus according to an exemplary embodiment of the present disclosure will now be described in greater detail with reference to the accompanying drawing figures.

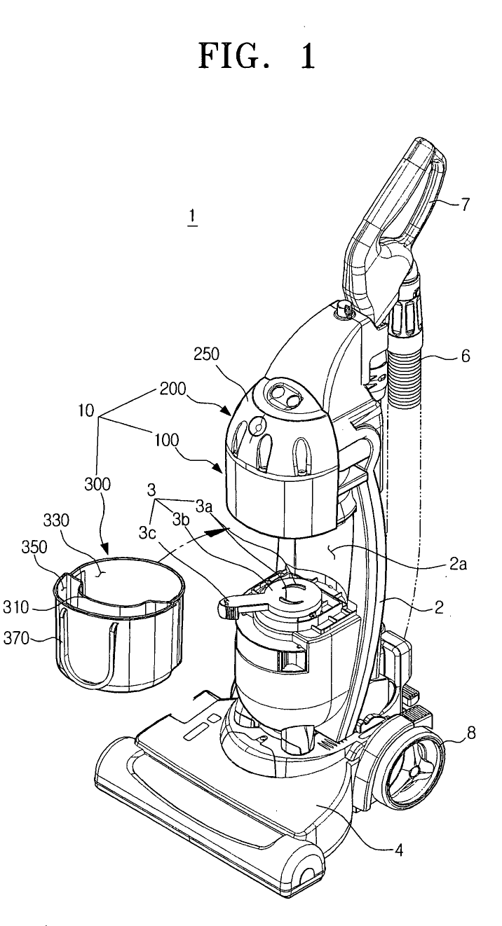

Referring to FIG. 1, a vacuum cleaner I according to the exemplary embodiment of the present disclosure includes a cleaner main body 2, a suction port body 4 and a cyclone dust-collecting apparatus 10.

The cleaner main body 2 includes a suction motor (not illustrated) disposed thereinside, and a lift unit 3 disposed below the cyclone dust-collecting apparatus 10. The cyclone dust-collecting apparatus 10 is disposed in front of the cleaner main body 2.

The lift unit 3 raises or lowers a dust-collecting unit 300 of the cyclone dust-collecting apparatus 10 so that the dust-collecting unit 300 may be securely fastened to a cyclone unit 100, or may be separated from the cyclone unit 100 and removed from the cleaner main body 2. The lift unit 3 includes a pair of center ribs 3a to raise or lower the dust-collecting unit 300, a rotating plate 3b to make the pair of center ribs 3a rotate, and a lever 3c to manipulate the rotating plate 3b.

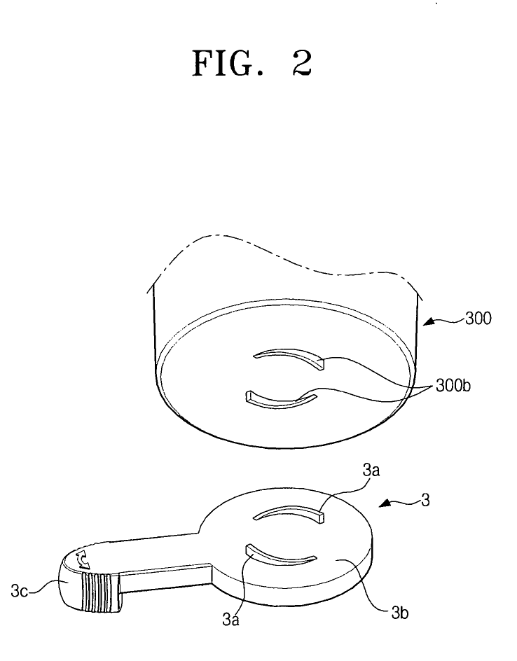

The pair of center ribs 3a have a predetermined curvature and protrude from the top surface of the rotating plate 3b, and the center of the pair of center ribs 3a is coincident with the rotational axis of the rotating plate 3b. The pair of center ribs 3a are tilted towards each other. Referring to FIG. 2, the dust-collecting unit 300 includes a pair of ribs 300b, which are disposed on the bottom center surface thereof and which correspond to the pair of center ribs 3a of the lift unit 3. The pair of ribs 300b of the dust-collecting unit 300 are inclined in a direction opposite the direction of the slant of the pair of center ribs 3a of the lift unit 3. Accordingly, if the pair of center ribs 3a rotate clockwise or counterclockwise, the dust-collecting unit 300 may be raised or lowered by the pair of ribs 300b.

The rotating plate 3b is rotatably mounted on the cleaner main body 2 at a position corresponding substantially to the center of the dust-collecting unit 300.

One end of the lever 3c is connected to the rotating plate 3b, and the other end thereof protrudes from the front of the cleaner main body 2 substantially perpendicularly to a center axis of the cleaner main body 2, so that the lever 3c is able to rotate a predetermined angle clockwise or counterclockwise.

The suction port body 4 is hingeably connected to a lower portion of the cleaner main body 2. The suction port body 4 includes a suction port (not illustrated) formed on the bottom surface thereof to draw in dust from a surface being cleaned.

In FIG. 1, reference numerals 6, 7 and 8 represent a flexible hose, a manipulating handle and wheels, respectively.

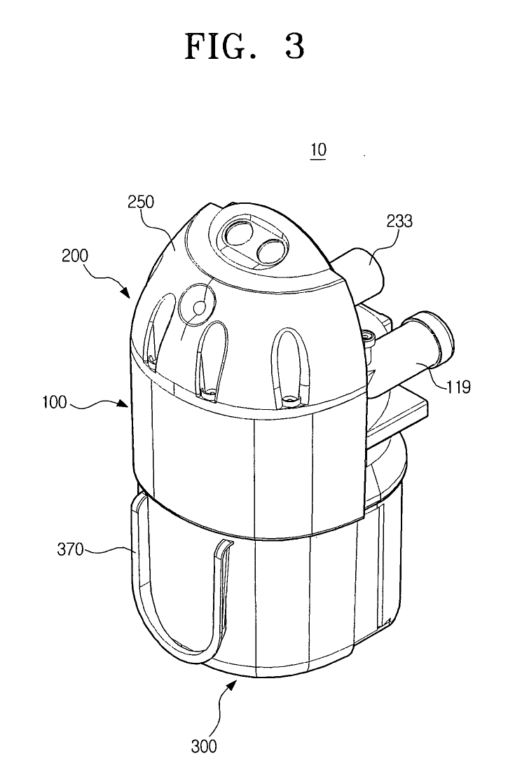

Hereinafter, the configuration of the cyclone dust-collecting apparatus 10 will be described in detail with reference to FIGS. 3 to 10.

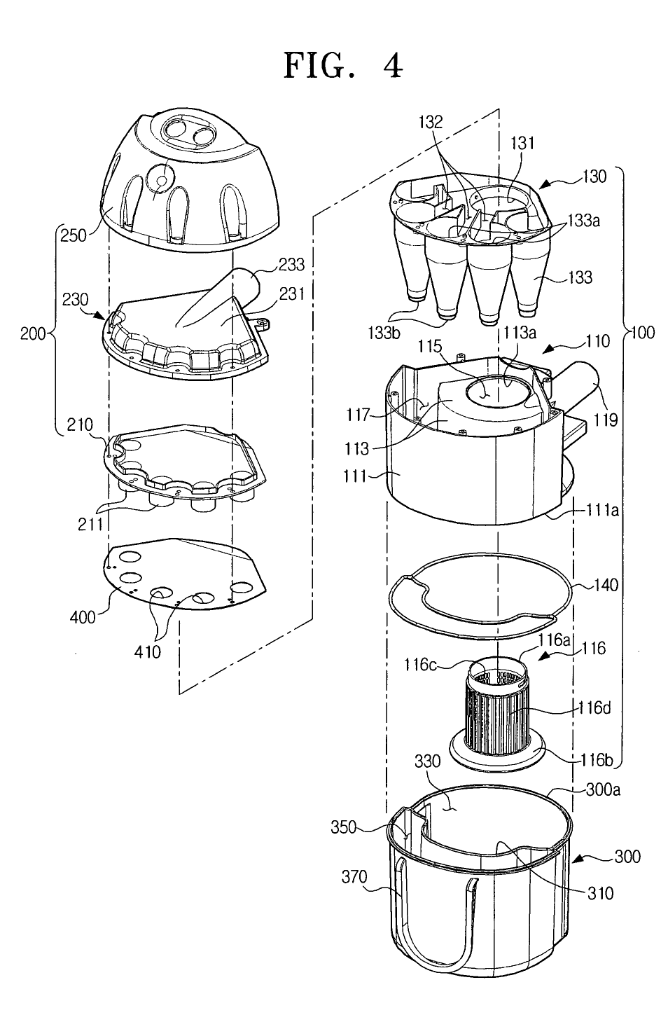

Referring to FIGS. 3 and 4, the cyclone dust-collecting apparatus 10 includes the cyclone unit 100, a cover unit 200 and the dust-collecting unit 300.

The cyclone unit 100 centrifugally separates dust from dust-laden air drawn inside the cleaner main body 2 from the surface being cleaned through the suction port body 4. The cyclone unit 100 includes a primary cyclone unit 110 to separate relatively large dust from air, and a secondary cyclone unit 130 to separate relatively fine dust from air from which larger dust has been separated by the primary cyclone unit 110.

The primary cyclone unit 110 includes a body 111 with opened top and bottom portions. The body 111 is divided by a partition wall 113 into a cyclone chamber 115 and a housing space 117 to house a plurality of cones 133 of the secondary cyclone unit 130.

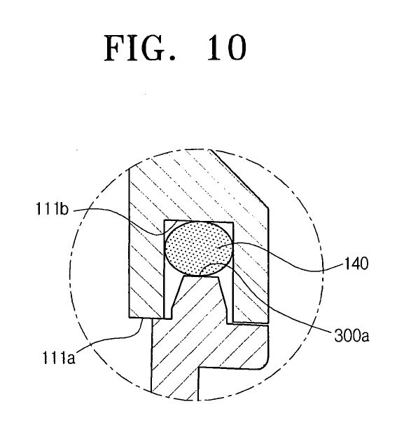

Additionally, the body 111 includes a recess 111b (see FIG. 10) that is formed along a bottom end 111a and into which a sealing 140 is inserted. The sealing 140 provides an airtight seal between the top end 300a of the dust-collecting unit 300 and the bottom end 111a of the body 111 when a user fastens the dust-collecting unit 300 to the cyclone unit 110 using the lever 3c, so it is possible to prevent a reduction in the pressure inside the cyclone unit 110, and also possible to prevent dust from leaking from the cyclone dust-collecting apparatus 10.

The cyclone chamber 115 is disposed inside the body 111 while deviating from the center of the body 111. The housing space 117 is formed around a portion of the partition wall 113. Additionally, the cyclone chamber 115 includes a grill filter 116 disposed therein to prevent relatively large dust separated from air by a centrifugal force from flowing into the secondary cyclone unit 130.

The top end 116a of the grill filter 116 is detachably inserted into an inlet hole 131 of the secondary cyclone unit 130 through an air discharge hole 113a formed on the partition wall 113. Additionally, the grill filter 116 has a skirt 116b protruding from the bottom edge of the grill filter 116 along an outer circumference thereof, to prevent dust, which has been separated from air inside the cyclone chamber 115 and collected in the dust-collecting unit 300, from being rescattered by an air current inside the cyclone chamber 115 and from flowing back into the cyclone chamber 115. Additionally, the grill filter 116 includes a plurality of grill pores 116c formed therethrough, and a plurality of guide blades 116d extending from the outer surface thereof to enclose the plurality of grill pores 116c.

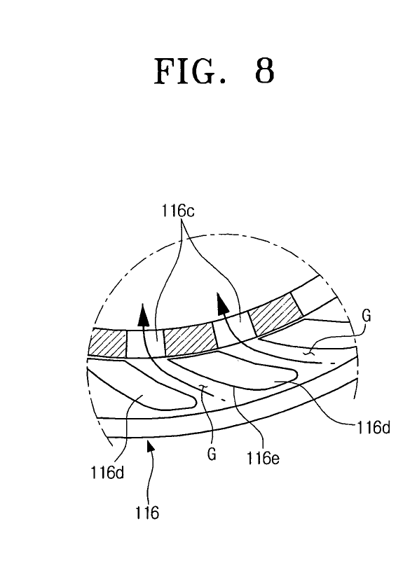

The plurality of guide blades 116d are spaced apart from each other by predetermined gaps G (see FIG. 8), so that air may pass through the plurality of guide blades 116d. The plurality of guide blades 116d are inclined in the same direction as the direction in which air flowing into the cyclone chamber 115 through an inlet pipe 119 is made to whirl. Accordingly, if the plurality of grill pores 116c are formed substantially perpendicular to air flowing into the cyclone chamber 115, it is possible to eliminate problems occurring in the conventional cyclone dust-collecting apparatus, for example, it is possible to prevent vortexes in a stagnant flow from being formed on a trailing surface 116e of the plurality of grill pores 116c which faces air flowing into the cyclone chamber 115. Additionally, it is also possible to prevent dust from being stacked adjacent to the trailing surface 116e of the plurality of grill pores 116c as a result of the vortex stagnation. Furthermore, the plurality of guide blades 116d continue to guide air flowing into the cyclone chamber 115 towards the grill filter 116 without needing to change the airflow path, so the number of unnecessary flow paths may be reduced.

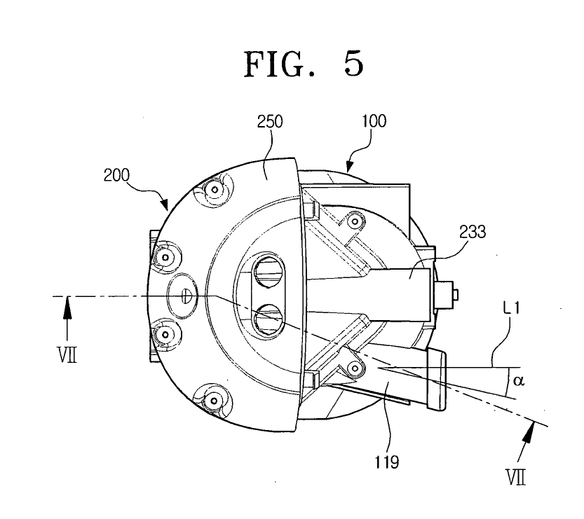

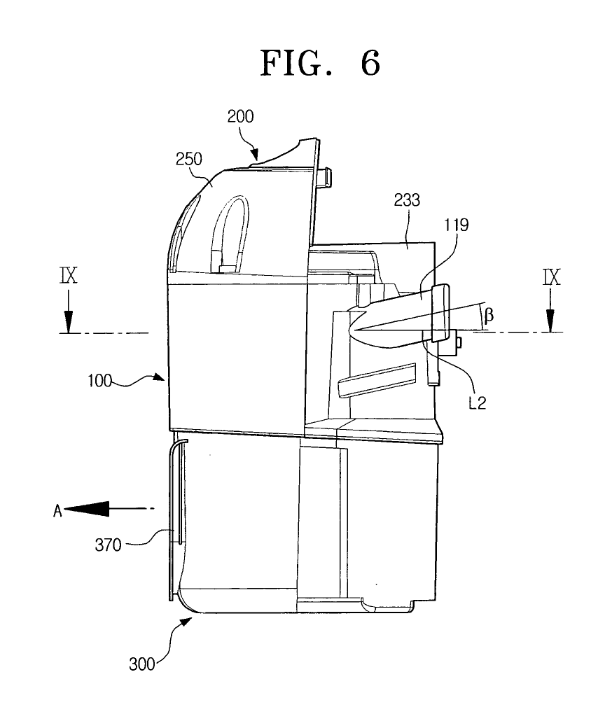

The primary cyclone unit 110 includes the inlet pipe 119 disposed in one side thereof to guide dust and air towards the cyclone chamber 115. Referring to FIG. 5, the inlet pipe 119 is inclined by a first angle α (alpha) about a line L1 indicating the tangential direction of the primary cyclone unit 110. Referring to FIG. 6, the inlet pipe 119 is inclined by a second angle β (beta) upwards from a line L2 perpendicular to the center axis of the cyclone dust-collecting apparatus 10.

The first angle α (alpha) may desirably be in a range of 0 to 20 degrees, because if the first angle α (alpha) is less than 0 degrees, air may directly collide with an inner wall of the cyclone chamber 115, so the whirling force, and thus the dust-collecting efficiency, may be reduced. Alternatively, if the first angle α (alpha) is greater than 20 degrees, drawn-in air may directly collide with the grill filter 116, so the whirling force may be reduced, and dust contained in the air which has not been filtered may flow into the grill filter 116 and may block some portion of the grill filter 116, which causes a reduction in the suction force inside the cyclone chamber 115 and weakens the functioning of the grill filter 116.

The second angle β (beta) may desirably be in a range of 0 to 30 degrees, because if the second angle β (beta) is less than 0 degrees, drawn-in air may flow upwards inside the cyclone chamber 115 and thus collide with an upper inner surface of the partition wall 113, so the whirling force, and thus the efficiency for centrifugally separating dust and air, may be reduced. Alternatively, if the second angle β (beta) is greater than 30 degrees, air may flow towards the bottom of the cyclone chamber 115, so a flow path by which air from which dust has been separated flows towards the grill filter 116 may become longer, which causes pressure loss and a reduction in the suction force to draw in dust.

As described above, the inlet pipe 119 is inclined by the first angle α (alpha) and second angle β (beta), so it is possible to conceal the fact that a discharge port (not illustrated) of the cleaner main body 2 connected to the inlet pipe 119 is not aligned with the lines L1 and L2 due to design problems occurring when a mold is fabricated in order to form the cleaner main body 2, and simultaneously to minimize the pressure loss occurring inside the cyclone unit 100 and a reduction in the suction efficiency.

While the inlet pipe 119 is inclined both horizontally and vertically within the range of the first angle α (alpha) and second angle β (beta) in the exemplary embodiment of the present disclosure, there is no limitation thereto. Accordingly, the present disclosure is applicable to a situation in which the inlet pipe 119 is inclined by either the first angle α (alpha) or second angle β (beta) according to the design conditions of a mold of the cleaner main body 2.

Additionally, the grill filter 116 includes both the plurality of grill pores 116c and plurality of guide blades 116d in the exemplary embodiment of the present disclosure, but there is no limitation thereto. Accordingly, the present disclosure is applicable to a situation in which the grill filter 116 includes only the plurality of guide blades 116d.

The secondary cyclone unit 130 includes an inlet hole 131, the plurality of cones 133 and a plurality of guide channels 132. The inlet hole 131 is formed on a first side of the secondary cyclone unit 130 and functions as an inlet into which air discharged through the air discharge hole 113a of the primary cyclone unit 110 flows. The plurality of cones 133 are formed on a second side thereof, arranged along the center axis of the cyclone dust-collecting apparatus 10 and received in the housing space 117 of the primary cyclone unit 110. Additionally, the plurality of guide channels 132 are formed between the inlet hole 131 and the plurality of cones 133, to guide air flowing through the inlet hole 131 towards a plurality of inlets 133a of the plurality of cones 133. The plurality of guide channels 132 are disposed tangentially in fluid communication with the plurality of inlets 133a of the plurality of cones 133, and accordingly air flowing into the plurality of inlets 133a may be made to whirl inside the plurality of cones 133, so that relatively fine dust may be separated from the air using the centrifugal force.

Each of the plurality of cones 133 has a length less than that of the body 111 such that they may be housed inside the body 111. Accordingly, it is possible to prevent the plurality of cones 133 from interfering with the dust-collecting unit 300 when the dust-collecting unit 300 is detached from or attached to the cyclone unit 100 in direction A (see FIG. 6) perpendicular to the center axis of the cyclone dust-collecting apparatus 10.

The cover unit 200 is disposed above the cyclone unit 100, and includes a first cover 210 and second cover 230.

The first cover 210 closes an upper portion of the secondary cyclone unit 130, and a gasket 400 is mounted between the first cover 210 and secondary cyclone unit 130 to form an airtight seal on the upper portion of the secondary cyclone unit 130. Additionally, the first cover 210 includes a plurality of discharge pipes 211 disposed above the plurality of cones 133 of the secondary cyclone unit 130. The plurality of discharge pipes 211 penetrate through a plurality of insertion holes 410 formed on the gasket 400, and are disposed above and coaxially with the plurality of cones 133.

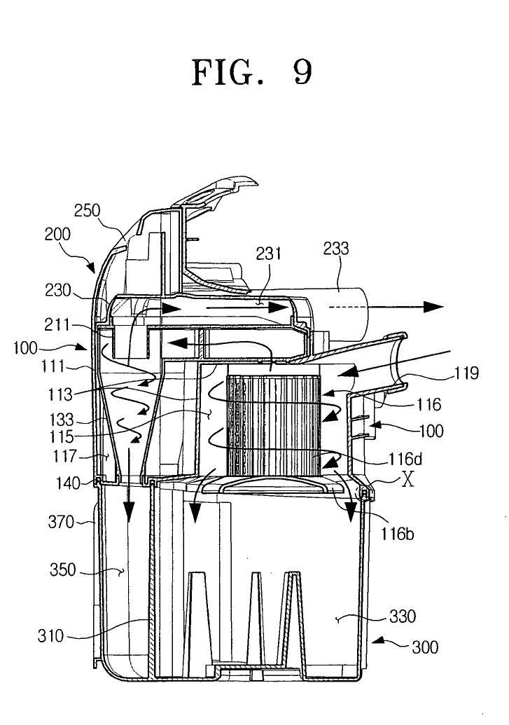

The second cover 230 is connected to an upper portion of the first cover 210, and includes a confluent chamber 231 (see FIG. 9) in which air discharged via the plurality of discharge pipes 211 of the first cover 210 is collected. Additionally, the second cover 230 includes an outlet pipe 233 to discharge the air collected in the confluent chamber 231 from the cyclone dust-collecting apparatus 10. The outlet pipe 233 fluidly communicates with a connection hole (not illustrated) fluidly communicating with the suction motor (not illustrated) mounted inside the cleaner main body 2. The second cover 230 is detachably mounted above an external cover 250.

The dust-collecting unit 300 is disposed below the cyclone unit 100, and is divided into a primary dust-collecting chamber 330 and secondary dust-collecting chamber 350 by a partition wall 310. The primary dust-collecting chamber 330 is disposed below the cyclone chamber 115 to collect relatively large dust separated by the primary cyclone unit 110, and the secondary dust-collecting chamber 350 is disposed below the housing space 117 to collect relatively fine dust separated by the secondary cyclone unit 130.

Hereinafter, operations of the cyclone dust-collecting apparatus 10 configured as described above, and vacuum cleaner 1 having the cyclone dust-collecting apparatus 10 will be described.

If a user rotates the lever 3c either clockwise or counterclockwise when the dust-collecting unit 300 is housed in a space 2a of the cleaner main body 2 below the cyclone unit 100, the pair of center ribs 3a rotating in the same direction as the rotating plate 3b made to rotate by the lever 3c may push up the pair of ribs 300b while being in contact with the pair of ribs 300b, so as to raise the dust-collecting unit 300. The raised dust-collecting unit 300 may be securely fastened below the cyclone unit 100 while maintaining the airtight seal therebetween.

Subsequently, the suction motor (not illustrated) in the cleaner main body 2 may be operated and cleaning may be performed. Dust-laden air drawn inside the cleaner main body 2 through the suction port (not illustrated) of the suction port body 4 flows into the cyclone chamber 115 of the primary cyclone unit 110 through the inlet pipe 119 of the cyclone unit 100.

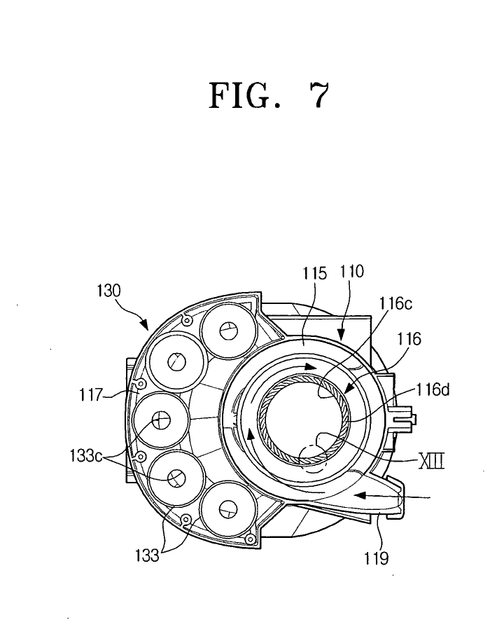

Referring to FIGS. 7 and 9, the dust-laden air flowing into the cyclone chamber 115 through the inlet pipe 119 is made to whirl inside the cyclone chamber 115, so that relatively large dust is separated from the dust-laden air and falls down along the inside of the partition wall 113 while whirling. The relatively large dust is then collected in the primary dust-collecting chamber 330, and air from which the relatively large dust has been separated flows into the grill filter 116 through the gaps G (see FIG. 8) between the plurality of guide blades 116d of the grill filter 116 and via the plurality of grill pores 116c. Since the plurality of guide blades 116d are inclined in the same direction as the whirling air current, the vortex stagnation no longer occurs around the plurality of guide blades 116d, and it is thus possible to prevent dust from being stacked adjacent to the trailing surface 116e of the plurality of guide blades 116d.

After the air from which the relatively large dust has been separated flows into the grill filter 116, the air flows into the secondary cyclone unit 130 via the inlet hole 131. Subsequently, the air flows into the plurality of cones 133 along the plurality of guide channels 132 (see FIG. 4), and is then made to whirl inside the plurality of cones 133. Accordingly, relatively fine dust is separated from the air using the centrifugal force, and the separated relatively fine dust drops and is collected in the secondary dust-collecting chamber 350 of the dust-collecting unit 300. Air from which the relatively fine dust has been separated is discharged from the plurality of cones 133 to the confluent chamber 231 of the second cover 230 via the plurality of discharge pipes 211.

The air discharged to the confluent chamber 231 is discharged from the cyclone dust-collecting apparatus 10 via the outlet pipe 233, and is then discharged from the cleaner main body 2 along the center axis of the cleaner main body 2.

In order to empty the dust-collecting unit 300 after cleaning is completed, if the user rotates the lever 3c in a direction opposite the direction in which the lever 3c is rotated to fasten the dust-collecting unit 300, the pair of center ribs 3a may lower the dust-collecting unit 300 while sliding in the same direction as the rotation of the lever 3c along the pair of ribs 300b of the dust-collecting unit 300, so that the lowered dust-collecting unit 300 may be separated from the cyclone unit 100. Accordingly, it is possible for the user to easily remove the dust-collecting unit 300 from the space 2a of the cleaner main body 2.

The cyclone unit 100 is detachably engaged with the dust-collecting unit 300 in the cyclone dust-collecting apparatus 10 according to the exemplary embodiment of the present disclosure, so it is possible for a user to easily separate only the dust-collecting unit 300 from the cleaner main body 2 when he or she desires to remove dust from the dust-collecting unit 300.

As described above, according to the exemplary embodiment of the present disclosure, it is possible to increase the performance of a cyclone dust-collecting apparatus, to provide a user with greater convenience when using a vacuum cleaner having the cyclone dust-collecting apparatus, and to enhance the efficiency of maintenance and repair.

Although representative exemplary embodiment of the present disclosure has been illustrated and described in order to exemplify the principle of the present disclosure, the present disclosure is not limited to the specific exemplary embodiment. It will be understood that various modifications and changes can be made by one skilled in the art without departing from the spirit and scope of the disclosure as defined by the appended claims. Therefore, it shall be considered that such modifications, changes and equivalents thereof are all included within the scope of the present disclosure.

What is claimed is:

1. A cyclone dust-collecting apparatus comprising:
a cyclone unit comprising a primary cyclone unit having a grill filter formed therein, and a secondary cyclone unit that is in fluid communication with the primary cyclone unit;
a cover unit detachably disposed above the cyclone unit to discharge air discharged from the secondary cyclone unit; and
a dust-collecting unit that collects dust separated by the primary and secondary cyclone units, and that is detachably disposed below the cyclone unit,
wherein air flows into the grill filter in the same direction as air flows into the primary cyclone unit.

2. The cyclone dust-collecting apparatus of claim 1, wherein the grill filter comprises a plurality of guide blades that extend radially from an outer surface of the grill filter, are spaced apart from each other by regular gaps and inclined in the same direction.

3. The cyclone dust-collecting apparatus of claim 1, wherein the primary cyclone unit and the secondary cyclone unit are detachably engaged.

4. The cyclone dust-collecting apparatus of claim 3, wherein the primary cyclone unit further comprises:
a body having an inlet pipe formed in one side thereof;
a cyclone chamber disposed inside the body while deviating from the center of the body; and
a housing space partitioned from the cyclone chamber, and
wherein the inlet pipe is inclined by a first angle about a line indicating a tangential direction of the cyclone chamber or by a second angle upwards from a line perpendicular to a center axis of the cyclone dust-collecting apparatus, or by both the first angle and second angle.

5. The cyclone dust-collecting apparatus of claim 4, wherein the first angle is in a range of 0 to 20 degrees.

6. The cyclone dust-collecting apparatus of claim 4, wherein the second angle is in a range of 0 to 30 degrees.

7. The cyclone dust-collecting apparatus of claim 4, wherein the secondary cyclone unit comprises a plurality of cones that are received in the housing space of the primary cyclone unit to enclose one side of the cyclone chamber.

8. The cyclone dust-collecting apparatus of claim 7, wherein bottom ends of the plurality of cones are in contact with or disposed above a bottom end of the primary cyclone unit.

9. The cyclone dust-collecting apparatus of claim 7, wherein the cover unit comprises:
a first cover having a plurality of discharge pipes disposed above the plurality of cones to guide air discharged from the secondary cyclone unit; and
a second cover comprising a confluent chamber in which air discharged via the plurality of discharge pipes is collected, and an outlet pipe to discharge the air collected in the confluent chamber from the cyclone dust-collecting apparatus.

10. The cyclone dust-collecting apparatus of claim 9, further comprising:
a gasket inserted between the first cover and secondary cyclone unit to form an airtight seal on an upper portion of the secondary cyclone unit.

11. A cyclone dust-collecting apparatus comprising:
a cyclone unit comprising a primary cyclone unit including an inlet pipe and a cyclone chamber in which a grill filter is disposed, and a secondary cyclone unit that is in fluid communication with the primary cyclone unit and includes a plurality of cones enclosing one side of the cyclone chamber;
a cover unit detachably disposed above the cyclone unit to temporarily accept air discharged from the secondary cyclone unit, the cover unit having an outlet pipe disposed on a side thereof to discharge the accepted air; and
a dust-collecting unit detachably disposed below the cyclone unit, the dust-collecting unit comprising a primary dust-collecting chamber and secondary dust-collecting chamber that are partitioned from each other to collect dust separated by the primary cyclone unit and secondary cyclone unit,
wherein the grill filter comprises a plurality of guide blades that extend from the outer surface thereof along the center of the grill filter, are spaced apart from each other by regular gaps and inclined in the same direction, in order to cause air to flow into the grill filter in the same direction as air flows into the primary cyclone unit.

12. The cyclone dust-collecting apparatus of claim 11, wherein the inlet pipe is inclined by a first angle about a line indicating the tangential direction of the cyclone chamber or by a second angle upwards from a line perpendicular to a center axis of the cyclone dust-collecting apparatus, or by both the first angle and second angle.

13. The cyclone dust-collecting apparatus of claim 12, wherein the first angle is in a range of 0 to 20 degrees.

14. The cyclone dust-collecting apparatus of claim 12, wherein the second angle is in a range of 0 to 30 degrees.

15. A cyclone dust-collecting apparatus comprising:
a cyclone unit comprising a grill filter disposed therein and an inlet pipe disposed on one side thereof, the inlet pipe having a center axis; and
a dust-collecting unit detachably disposed below the cyclone unit,
wherein the center axis of the inlet pipe is disposed between the grill filter and the cyclone unit.

16. The cyclone dust-collecting apparatus of claim 15, wherein the inlet pipe is inclined horizontally at an angle in a range of 0 to 20 degrees.

17. The cyclone dust-collecting apparatus of claim 15, wherein the inlet pipe is inclined upwards from a line perpendicular to a center axis of the cyclone dust-collecting apparatus,

18. The cyclone dust-collecting apparatus of claim 17, wherein the inlet pipe is inclined vertically in a range of 0 to 30 degrees.

19. The cyclone dust-collecting apparatus of claim 15, wherein the grill filter comprises a plurality of guide blades that extend radially from an outer surface thereof, are spaced apart from each other by regular gaps and inclined in the same direction, in order to cause air to flow into the grill filter in the same direction as air flows into the primary cyclone unit.

20. A vacuum cleaner comprising:
a cleaner main body comprising a suction motor mounted therein;
a suction port body hingeably connected to a lower portion of the cleaner main body in fluid communication therewith;
a cyclone dust-collecting apparatus mounted in the cleaner main body; and
a lift unit disposed below the cyclone dust-collecting apparatus in the cleaner main body,
wherein the cyclone dust-collecting apparatus comprises:
a cyclone unit comprising a primary cyclone unit having a grill filter formed therein, and a secondary cyclone unit that is in fluid communication with the primary cyclone unit;
a cover unit detachably disposed above the cyclone unit to discharge air discharged from the secondary cyclone unit; and
a dust-collecting unit detachably disposed below the cyclone unit to collect dust separated by the primary cyclone unit and secondary cyclone unit,
wherein air flows into the grill filter in the same direction as air flows into the primary cyclone unit; and
wherein the lift unit securely fastens the dust-collecting unit to the cyclone unit in cleaning mode, or separates the dust-collecting unit from the cyclone unit in order to detach the dust-collecting unit from the cleaner main body.
